(19) United States
(12) Patent Application Publication
(10) Pub. No.: US 2009/0014380 A1
(43) Pub. Date: Jan. 15, 2009

(54) APPARATUS, SYSTEMS, AND METHODS FOR DISTRIBUTING EFFLUENT IN MOUND ELIMINATION UNITS AND OTHER DRAINFIELD INSTALLATIONS

(76) Inventor: Randall J. HOUCK, St. Augustine, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/184,850

(22) Filed: Aug. 1, 2008

Related U.S. Application Data
(63) Continuation-in-part of application No. 10/702,857, filed on Nov. 6, 2003, now abandoned.
Application No. 10/702,857 is a continuation-in-part of application No. 10/994,809, filed on Nov. 22, 2004, now abandoned.
Application No. 10/994,809 is a continuation-in-part of application No. 11/433,794, filed on May 11, 2006.
Application No. 11/433,794 is a continuation-in-part of application No. 11/543,305, filed on Oct. 4, 2006.

(51) Int. Cl. B01D 21/24

(52) U.S. Cl. 210/417

(57) ABSTRACT

In an effluent treatment system, a distribution grid comprises a distribution member for passing effluent initially horizontally through an internal chamber and out of laterally-extending distribution arms communicating with the chamber. Prefabricated filter media units are placed under the distribution member and the arms so that effluent may then trickle generally vertically through the filter media.

### CROSS-REFERENCE

This application is a continuation-in-part of the following applications: Ser. No. 10/702,857 filed Nov. 6, 2003; Ser. No. 10/994,809 filed Nov. 22, 2004; Ser. No. 11/433,794 filed May 11, 2006; and Ser. No. 11/543,305 filed Oct. 4, 2006. The disclosures of these earlier related applications are incorporated herein by reference. This application also claims priority to related provisional applications 60/723,507 filed Oct. 4, 2005 and Ser. No. 60/714,473 filed Sep. 6, 2005.

### BACKGROUND

In the United States, a growing number of households rely upon a septic system rather than centralized wastewater treatment facilities. In fact, approximately one fourth of the households in the United States use a septic system to treat, filter, clean and disburse wastewater. A typical septic system consists of a septic tank, a distribution/filtration box, and some form of an underground disposal field. Several types of underground disposal fields have been developed and are known in the art. The most common type is a drainfield, also known as a leach field or absorption field. There have been several variations of drainfields, including mound systems, sand filters, and dig outs.

Once sewage undergoes treatment in a septic tank, the resulting effluent is transported to the drainfield. This is accomplished by either gravity or through a mechanical pump, with the goal of uniformly discharging effluent below ground into the soil for final treatment and disposal. Another goal of the drainfield is to naturally filter the post-septic tank effluent to remove any remaining pathogens, bacteria or biomass prior to flowing into the ground water. Sizing of a drainfield depends upon several factors including the available area on the property, the number of individuals in the household, water usage habits of the household, on-site soil conditions, and government regulations. One typical form of a drainfield comprises a collection of multiple parallel-perforated pipes connected by one or more distribution pipes that allow distribution of effluent into the surrounding ground soil for filtration.

Historically, construction of a drainfield has been expensive, time consuming, and inconvenient. Construction usually begins with the excavation of multiple trenches to lay the necessary perforated pipes. These trenches are usually less than 100 feet long and dug to create an essentially flat bottom. In one prior art drainfield construction, each trench is first filled with a layer of gravel. Next, a perforated pipe is placed in the trench, with an additional six-inch layer of gravel added to surround the perforated pipe. If required, a geotextile fabric or a similar product is placed over the gravel. Finally, a covering layer of backfill soil is added. This entire process requires transport of large amounts of gravel, backfill soil, and pipe from a distribution center to the drainfield site. The steps of digging trenches, creating a network of pipes, and laying different layers of filtering media requires specialized equipment, multiple experienced workers, time, and large quantities of natural resources (i.e., soil and gravel).

In many areas of the country, unique soil conditions require a modified drainfield known as a mound or raised drainfield. In areas with a high groundwater level, shallow soil over impermeable soil, or slowly permeable soil, a mound must be created above ground to allow proper distribution and filtration of post-septic effluent. Above-ground mounds, however, often require a mechanical pump to raise effluent from the septic tank above ground to the mound. Second, a mound requires transport of additional natural resources to the site. Third, a mound is typically unsightly and greatly reduces the use and value of the land. Last, a mound requires a relatively larger area than a conventional drainfield and also requires routine monitoring and maintenance.

One prior art alternative for a mound or raised drainfield is a sand filter that uses a water impermeable basin placed in the ground to contain a sand bed, with a network of perforated pipes located in the sand bed. The water impermeable basin is first filled with a layer of aggregate, most commonly pea gravel. Next, a second layer of medium grade clean sand is added to the basin to create the sand bed. A network of perforated pipes is placed on top of the sand bed, and a second layer of aggregate is then added to the basin. A larger perforated outflow pipe is typically placed within the basin for collection of filtered effluent that then enters the drainfield.

Although sand filters may avoid the need for a mound, thus improving the appearance of the underground disposal field and allowing for better use of the ground, sand filters have several disadvantages. First, large volumes of heavy sand must be transported to the drainfield site, which can be very costly. Second, sand filters require very large cross sections to be effective. For example, a typical two-bedroom home typically requires a sand filter nineteen feet by nineteen feet in cross-section. Thus, these systems can only work with large acreage households. Third, most sand filters require a mechanical pump, resulting in greater energy and maintenance costs.

A third type of drainfield called a “dig out” has also been used in the art. With a dig out, a large cross-sectional area of the soil near the septic tank is excavated to remove poor soil. Good quality soil is then transported to the site and evenly deposited in the excavated area. A network of perforated pipes is assembled and placed atop the newly deposited soil, which is connected to either a distribution box or directly to the septic tank. Backfill soil is then added over the network of perforated piping. While this method of creating a drainfield has some benefits with respect to a sand filter, the overall costs, manpower, and natural resources required to create a dig out system are significantly greater.

There exists a need for alternative systems and methods to sand filters, mound drainfields, and dig outs for efficient treatment, filtration, and distribution of effluent. In addition, there is a need for filter media in such alternative systems and methods that is lightweight, portable, inexpensive, and that will allow for increased filtration so as to decrease the cross-sectional size of these systems. The benefits of such filter media would be welcome in more typical drainfield installations as well, where the need for a less labor-intensive, more cost-effective system is also needed. Finally, there is a need for such systems to be modular for easy transport to the drainfield site, allowing improved fabrication of these systems to further reduce overall costs.

### SUMMARY

The present invention is directed to apparatus, systems, and methods for treating effluent in difficult soil conditions that historically required an undesirable installation such as an elevated mound, a sand filter, or a dig out. The present invention is also directed to apparatus, systems, and methods for treating effluent in areas where more typical drainfield methods are used. In addition, the present invention is directed to apparatus, systems, and methods for use in other applications, such as the treatment of effluent using low volume treatment techniques.

One embodiment of the present invention comprises a system for treating household effluent that includes a Mound Elimination Unit (“MEU”), a distribution grid, and filter media. (Note that the MEU is referred to as an “MRU,” for “Mound Reduction Unit,” in application Ser. No. 11/543,305.) The MEU is located downstream from a septic tank or similar discharge receptacle and is connected to the septic tank either directly or through an intermediate filtration subsystem. Aided by gravity, effluent leaves the septic tank and preferably travels to a filtration subsystem where it is treated with chlorine or any suitable agent to treat the effluent to remove bacteria and pathogens. The effluent then leaves the filtration unit through a second pipeline into the MEU. Within the MEU, a distribution grid uniformly distributes the effluent throughout the MEU, resulting in additional treatment and filtration of the effluent through a medium such as that described in U.S. Pat. No. 5,015,123 (“Patent '123”) or another suitable medium. In this way, levels of any remaining pathogens, bacteria, or human waste are significantly reduced. The treated and filtered effluent then leaves the MEU through an effluent transport, such as either a slotted linear grate or a series of screened portals, into a drainage unit where it is passed to a drainfield reserve. In appropriate circumstances, a pump is used to elevate the MEU outflow to the drainfield reserve.

Filter media fills a large majority of the volume of the MEU. The filter media is comprised of a suitable material for filtering effluent, such as sand, pea gravel, soil, rock, expanded polystyrene (“EPS”), or some combination thereof.

As mentioned earlier, the MEU houses a distribution grid. The distribution grid is positioned generally horizontally atop the filter media and in a preferred embodiment is constructed with a flat bottom so as to remain relatively stable atop the surface of the filter media. In the preferred embodiment, the distribution grid comprises a primary distribution member, lateral distribution arms, and a pipe adaptor. The pipe adaptor connects the primary distribution member to an inlet conduit. The inlet conduit conducts effluent into the distribution member through the pipe adaptor. The lateral distribution arms connect to the sides of the primary distribution member and extend laterally outward from it to span the surface of the filter media. Generally, three or more distribution arms extend from one side of the distribution member while two or more arms extend from the opposing side. Other configurations are possible, however. In the present embodiment, both the bottom of the primary distribution member and the bottoms of the lateral distribution arms contain perforations. As effluent flows throughout the distribution member and into the connected lateral distribution arms, it drains out through the perforations onto the filter media below.

The distribution grid can be made of any resilient material. A durable, lightweight plastic is preferable. The shape and dimensions of the distribution grid can also be altered to conform to the requirements of the filter media with which it is used. In some installations, for example, a primary distribution member may need to be wider and longer. In others, the distribution member may need to be narrower or perhaps shorter. Similarly, the shape and dimensions of the lateral distribution arms and the pipe adaptor may need to be altered as well to conform to the size of the primary distribution member, the characteristics of the filter media, or both, so as to ensure that the distribution grid works together as one functional unit.

It will, of course, be appreciated by those skilled in the art from the following detailed description that this innovative distribution grid can be used in conventional septic tank drainfield applications to achieve very favorable infiltrative capacity relative to prior art techniques, while at the same time permitting the use of shallower installations.

Both the distribution grid and the MEU are sized to allow for easy transport to a drainfield site via a commercial vehicle. Distribution grids within multiple MEUs can also be connected to one another in parallel or in series to allow for one system to include multiple MEUs.

Another embodiment of the present invention comprises a system for treating effluent that includes a Mound Elimination Unit (“MEU”), a distribution grid, and preassembled filter media. In this embodiment, the preferred filter media is a collection of preassembled EPS-netted cylinders like those disclosed in patent '123. The preassembled EPS-netted cylinders are comprised of EPS media packed into open netting. The EPS-netted cylinders may be arranged in multiple courses, each course stacked upon another. A distribution grid resides atop the uppermost course of cylinders. The bottom of the distribution grid is contoured in a convex shape so as to reside atop an EPS-netted cylinder with relative stability. Stability studs can also be used to further secure the distribution grid to a cylinder. The distribution grid is configured in generally the same fashion, and functions with the MEU in generally the same manner, as in the previous embodiment described earlier.

In addition to the preassembled EPS-netted units, other types of preassembled filter media can be used in the MEU as well. Among these are EPS-filled paper units, including EPS-filled paper cylinders, rectangular EPS-filled paper bags, and rectangular EPS-netted bags. These types of preassembled filter media can also be used in more typical drainfield applications, as discussed later. EPS-filled paper units are also the subject of further embodiments of the present invention, as also discussed later.

Another embodiment of the present invention is a method and apparatus for manufacturing preassembled EPS-netted units. The method and apparatus takes advantage of the efficacies of using a blower to produce the units, such as the elimination of undue static buildup on the pieces of EPS media. To produce an EPS-netted unit, netted material is placed over the exhaust outlet of a blower. The blower then blows EPS media into the netted material until the netting is filled to a desired capacity. The open end of the filled netted unit is then tied off, thereby creating a preassembled EPS-netted unit. The method and apparatus allow for the manufacture of EPS-netted units in a variety of lengths as well as in a range of diameters. The present embodiment envisions manufacturing EPS-netted units with a diameter from eight inches up to twenty inches. Other diameters, however, are also possible.

Another embodiment is a method and apparatus for manufacturing preassembled EPS-filled paper cylinders. An EPS-filled paper cylinder comprises perforated paper tubing into which EPS media is blown to fill the paper tubing to create an EPS-filled paper cylinder. The paper cylinders can be created in various lengths as well as in a range of diameters. The present embodiment envisions manufacturing paper cylinders with a diameter from eight inches up to twenty inches. Other diameters, however, are also possible.

The paper tubing of a preassembled EPS-filled paper cylinder serves as built-in barrier material. In more typical drainfield applications, the paper tubing functions like a geotextile fabric or similar product that is placed over aggregate or other filter media prior to covering the aggregate or filter media with backfill soil. This built-in functionality of the paper cylinders eliminates the need for such geotextile fabric or similar products in more typical drainfield installations. The EPS-filled paper cylinders also contain perforations in the paper to allow effluent to drain down into the EPS media contained within.

Another embodiment comprises a more typical drainfield for treating wastewater, such as household effluent. The drainfield includes a distribution grid and preassembled EPS-filled paper cylinders, like the kind described in the previous preferred embodiment. Generally, multiple preassembled EPS-filled paper cylinders are aligned side by side in an excavated trench. A distribution grid is set horizontally atop the EPS-filled paper cylinders, with the primary distribution member positioned atop the middle of the cylinders. The bottom of the primary distribution member is contoured in a convex shape so as to reside atop one of the EPS-filled paper cylinders with relative stability. Stability studs can also be used to further secure the primary distribution member to the paper cylinder. The entire drainfield is then covered with backfill soil. The paper tubing eliminates the need for using geotextile fabric or similar products prior to filling the excavated trench with soil. From its position atop the paper cylinders, the distribution grid is able to distribute effluent over a greatest volume of filter media, that filter media that is encased within the paper cylinders aligned side by side or beneath it.

Note that an alternate embodiment contemplates a drainfield comprising a distribution grid and preassembled EPS-netted cylinders. In this instance, the drainfield is covered with a geotextile fabric or similar product prior to filling the excavated trench with soil.

Another embodiment includes a method and apparatus for creating rectangular, preassembled, EPS-filled paper bags. An EPS-filled paper bag comprises perforated paper bag material into which EPS media is blown to fill the paper bag. In this embodiment, paper bag material is restrained within a jig prior to filling. The jig maintains the dimensions of the paper bag material as it is filled with ESP media, thus maintaining a generally standard rectangular shape from paper bag to paper bag. The dimensions of the jig are adjustable, allowing for the manufacture of paper bags of various shapes, widths, lengths, and heights.

Another embodiment of the present invention comprises a more typical drainfield for treating wastewater, such as household effluent. The drainfield includes a distribution grid and one or more of the above-described rectangular, preassembled, EPS-filled paper bags. If an EPS-filled paper bag is of sufficient width, then only one paper bag is required for the drainfield. If one paper bag is not of sufficient width, then generally three or more preassembled EPS-filled paper bags are aligned side by side in an excavated trench. A distribution grid is set horizontally atop the EPS-filled paper bags, with the primary distribution member positioned atop the middle of the bags. If only one paper bag is used, then the primary distribution member is positioned along the center of the bag. In this embodiment, the bottom of the primary distribution member is flat so as to reside atop the EPS-filled paper bag with relative stability. Stability studs can also be used to further secure the primary distribution member to the paper bag. The entire drainfield is then covered with backfill soil. The paper skin of the EPS-filled paper bags eliminates the need for using geotextile fabric or similar products prior to filling the excavated trench with soil. From its position atop the paper bags, the distribution grid is able to distribute effluent over a greatest volume of filter media.

### BRIEF DESCRIPTION OF THE DRAWINGS

Embodiments of the apparatus, systems, and methods of this invention are described by way of example with reference to the accompanying drawings in which:

FIG. 1 is a cross-sectional schematic view of a system utilizing an MEU;

FIG. 2 is a top schematic view of an embodiment of the present invention in which a distribution grid is used in conjunction with an MEU;

FIG. 3 is a cross-sectional perspective view of another embodiment in which a distribution grid is used in conjunction with an MEU employing preassembled filter media;

FIG. 4 is a perspective view of the distribution grid and a portion of the preassembled filter media shown in FIG. 3;

FIG. 5 is an exploded perspective view of the distribution grid shown in FIG. 4;

FIG. 6 is a perspective view of the bottom of a lateral distribution arm, which is a component of a distribution grid;

FIGS. 7-9 are top schematic views of alternate configurations for employing multiple distribution grids to connect together multiple mound elimination units in a system;

FIG. 10 is a schematic view of another embodiment in which a drainfield comprises a distribution grid and preassembled EPS-filled paper cylinders;

FIG. 11 is a perspective view of the drainfield shown in FIG. 10;

FIG. 12 is a perspective view of another embodiment in which a drainfield comprises a flat-bottomed distribution grid and a rectangular, preassembled, EPS-filled paper bag;

FIG. 13 is a perspective view of a second version of the drainfield shown in FIG. 12 in which multiple rectangular, preassembled, EPS-filled paper bags are employed;

FIG. 14 is a schematic view of another embodiment in which a method and apparatus are used to manufacture preassembled EPS-netted cylinders;

FIG. 15 is a schematic view of another embodiment in which a method and apparatus are used to manufacture preassembled EPS-filled paper cylinders;

FIG. 16 is a top schematic view of another embodiment in which a method and apparatus are used to manufacture rectangular, preassembled, EPS-filled paper bags;

FIG. 17 is a perspective view of a primary distribution member, which is a component of the distribution grid shown in FIG. 4, utilizing stability studs to secure the distribution grid to a unit of preassembled filter media as shown in FIG. 3;

FIG. 18 is an exploded perspective view of the primary distribution member and its stability studs shown in FIG. 17;

FIG. 19 is a cross-sectional perspective view of the primary distribution member and its stability studs shown in FIG. 17;

FIG. 20 is a cutaway perspective view of the primary distribution member and its stability studs shown in FIG. 17;

FIG. 21 is an exploded perspective view of a primary distribution member and its elongated stability studs;

FIG. 22 is a cutaway perspective view of the primary distribution member, shown in FIG. 21, utilizing its elongated stability studs to secure the distribution grid to a unit of preassembled filter media; and

FIG. 23 is a cross-sectional perspective view of the primary distribution member and its elongated stability studs shown in FIG. 21.

### DESCRIPTION

Various embodiments of the apparatus, systems, and methods of this invention are related to, and improvements of the mound elimination techniques described in application Ser. Nos. 11/433,794 and 11/543,305, both of which are incorporated herein by reference. Various embodiments of the apparatus, systems, and methods of this invention are also related to, and improvements of, more typical drainfield installations.

The invention encompasses a number of embodiments that will now be described with reference to the accompanying drawings. The invention may be embodied in many different forms and should not be construed as limited to the embodiments illustrated in the drawings and described herein. Those skilled in the art will appreciate that other embodiments of the present invention can be used in other applications, such as the treatment of effluent using low volume treatment techniques.

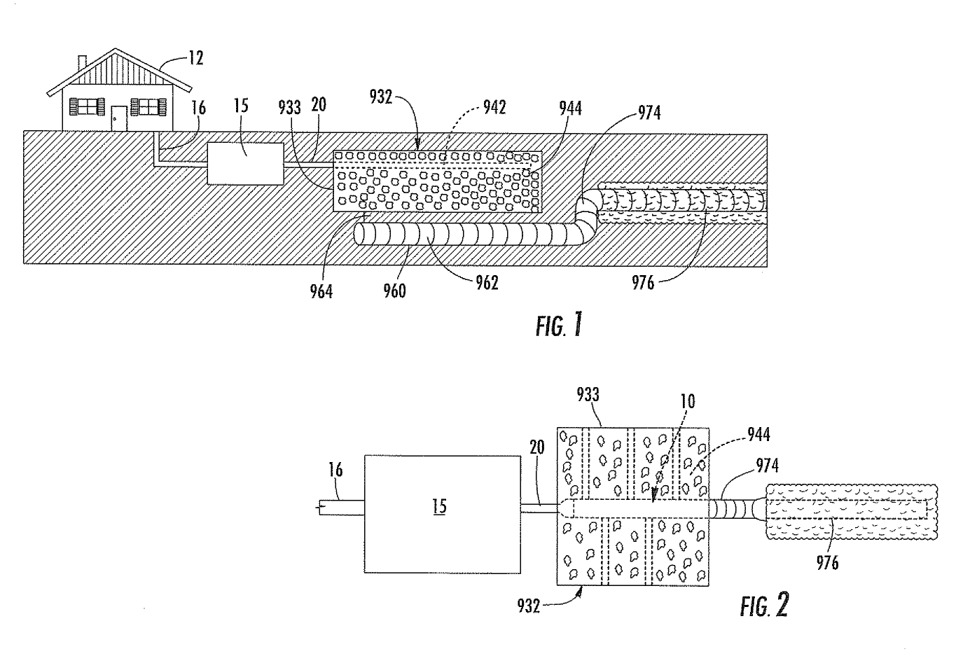

FIG. 1 shows a system for treating household effluent, in accordance with the system disclosed in application Ser. No. 11/543,305 (“Application '305”).

Referring to FIG. 1, the system described in application '305 comprises a household 12, a septic tank 15, a household effluent pipe 16, a conduit 20, a mound elimination unit (“MEU”) 932, a drainage unit 960, an “S” shaped unit 974, and a drainfield reserve 976. Wastewater flows from the household 12 to the septic tank 15 through the underground household effluent pipe 16. The effluent is initially treated inside the septic tank 15 before flowing out of the septic tank 15, through the conduit 20, and into the MEU 932. (Note that the MEU 932 is referred to as an “MRU,” for “Mound Reduction Unit,” in application '305.) The MEU 932 comprises an MEU housing 933, one or more perforated pipes 942, and filter media 944. The perforated pipe 942 and the filter media 944 are both housed within the MEU housing 933. The filter media 944 is comprised of a suitable material for filtering effluent, such as sand, pea gravel, soil, rock, expanded polystyrene (“EPS”), or some combination thereof. The filter media 944 fills a large majority of the volume of the MEU housing 933, leaving space at the top of the housing 933 for the perforated pipe 942. The perforated pipe 942 is positioned generally horizontally atop the upper surface of the filter media 944. The conduit 20 connects to the perforated pipe 942 that is housed within the MEU 932. Effluent flows through the conduit 20 and into the perforated pipe 942. As the effluent flows along the perforated pipe 942, the effluent slowly drains out of the pipe 942 onto the filter media 944 beneath. Impurities are left behind in the filter media 944 as the effluent drains down through the filter media 944 toward the bottom of the MEU housing 933, thereby further treating the effluent.

Continuing with FIG. 1, a drainage unit 960 is positioned generally horizontally below the MEU 932, but at an angle that allows the effluent to flow through the drainage unit 960 in a direction opposite the inlet to the MEU 932. The drainage unit 960 functions as a drain to direct the flow of effluent from the MEU 932. The drainage unit 960 comprises a discharge pipe 962 and a generally rectangular grated culvert 964. The grated culvert 964 is attached to the upper surface of the discharge pipe 962 and to the bottom surface of the MEU housing 933. The distal end of the discharge pipe 962 connects to an “S” shaped unit 974. The “S” shaped unit 974 is a pipe that is formed in an “S” shape. The “S” shaped unit 974 is positioned so that gravity will keep effluent flowing through the “S” shaped unit 974 in a direction opposite the inlet to the MEU 932. The distal end of the “S” shaped unit 974 feeds into a drainfield reserve 976. Effluent drains from the MEU 932 into the drainage unit 960. The effluent then flows through the drainage unit 960 into and through the “S” shaped unit 974 and into the drainfield reserve 976. Once in the drainfield reserve 976, the cleansed effluent slowly filters down through the soil, eventually reaching the water table. In some systems, a distribution/filtration subsystem is interposed between the septic tank 15 and the MEU 932. In these systems, the distribution/filtration subsystem performs some initial treatment of the effluent flowing from the septic tank 15 to remove portions of biomass, bacteria, and the like.

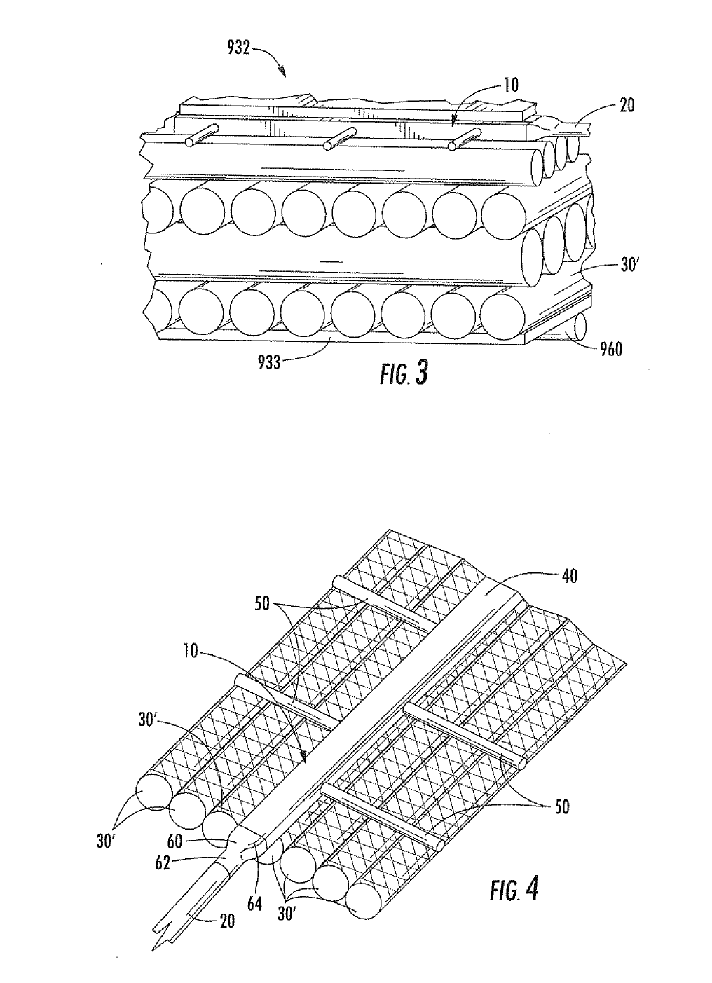

FIG. 2 shows a preferred embodiment in which a distribution grid 10, in accordance with the present invention, is used in conjunction with a system like an MEU 932 that employs traditional filter media 944 to treat wastewater such as household effluent. (As noted earlier, the MEU 932 is disclosed in application '305. In application '305 the MEU 932 is referred to as an “MRU”).

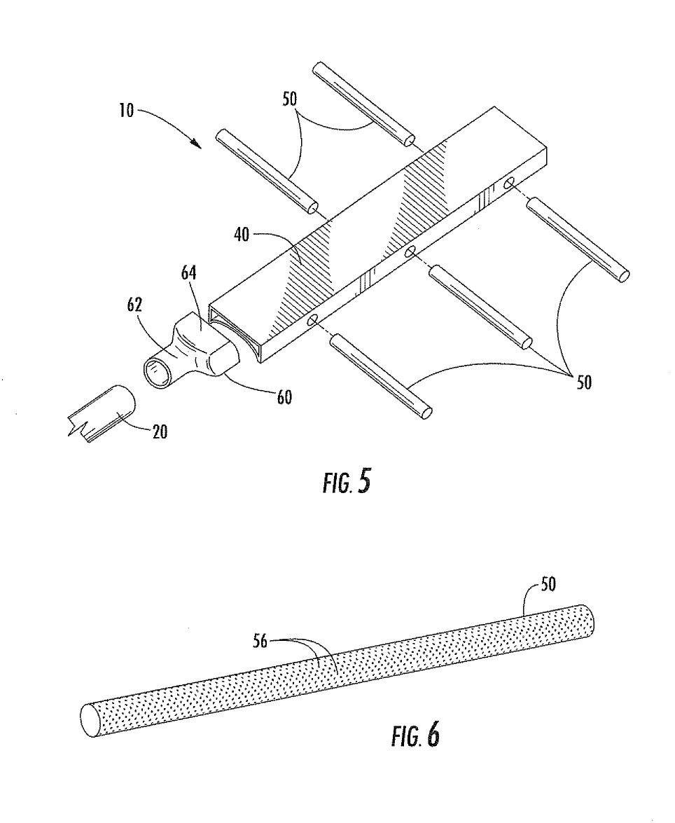

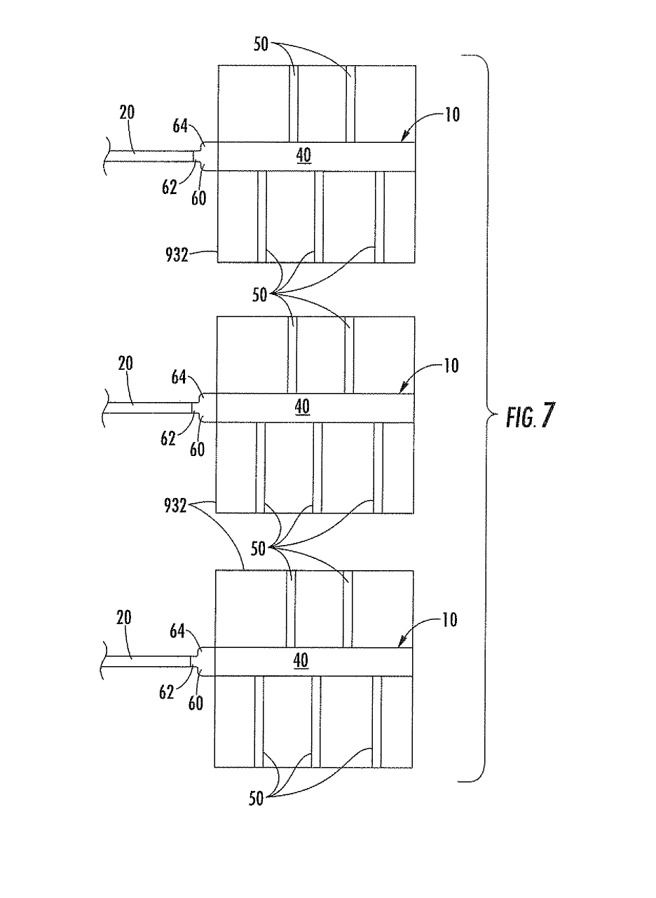

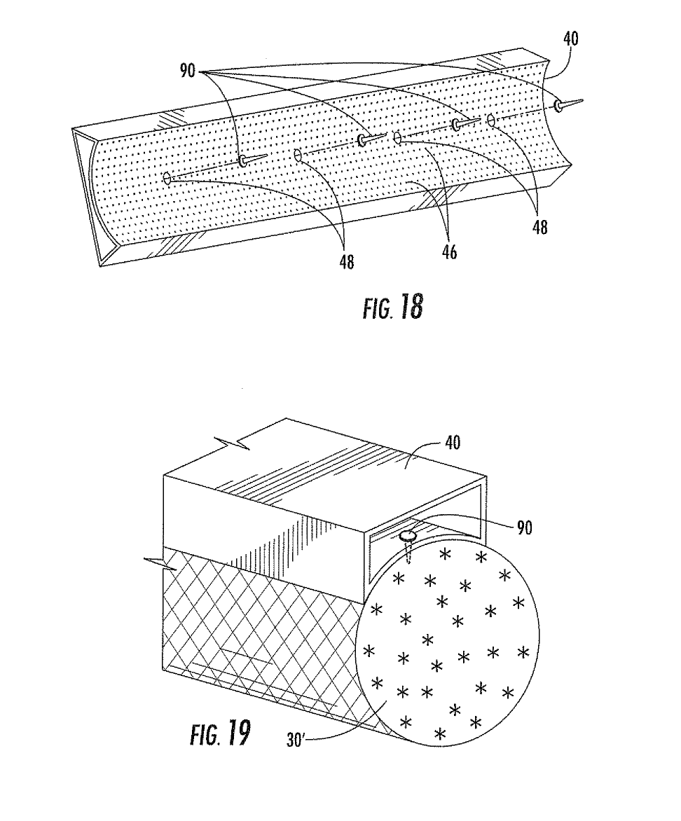

Referring to FIG. 2, an MEU 932 comprises a distribution grid 10, an MEU housing 933, and traditional filter media 944. The filter media 944 is comprised of a suitable material for filtering effluent, such as sand, pea gravel, soil, rock, EPS, or some combination thereof. The filter media 944 fills a large majority of the volume of the MEU housing 933, leaving space at the top of the housing 933 for a distribution grid 10. The distribution grid 10 is positioned generally horizontally atop the upper surface of the filter media 944, with the distribution grid 10 spanning the upper surface of the filter media 944. A conduit 20 connects to the distribution grid 10 that is housed within the MEU housing 933. (See FIGS. 4 and 5 for details.) Effluent flows through the conduit 20 into the distribution grid 10. Once inside the distribution grid 10, the effluent continues to flow throughout the span of the distribution grid 10, draining out through perforations 46, 56 (see FIGS. 6 and 18) in the distribution grid 10 onto the filter media 944 beneath. Impurities are left behind in the filter media 944 as the effluent drains down through the media 944 toward the bottom of the MEU housing 933. When the effluent reaches the bottom of the MEU housing 933, it drains into a drainage unit 960 (not shown, see FIG. 1). The effluent then flows through the drainage unit 960 and into and through other elements of the system until the cleansed effluent eventually reaches the water table, as described earlier in FIG. 1.

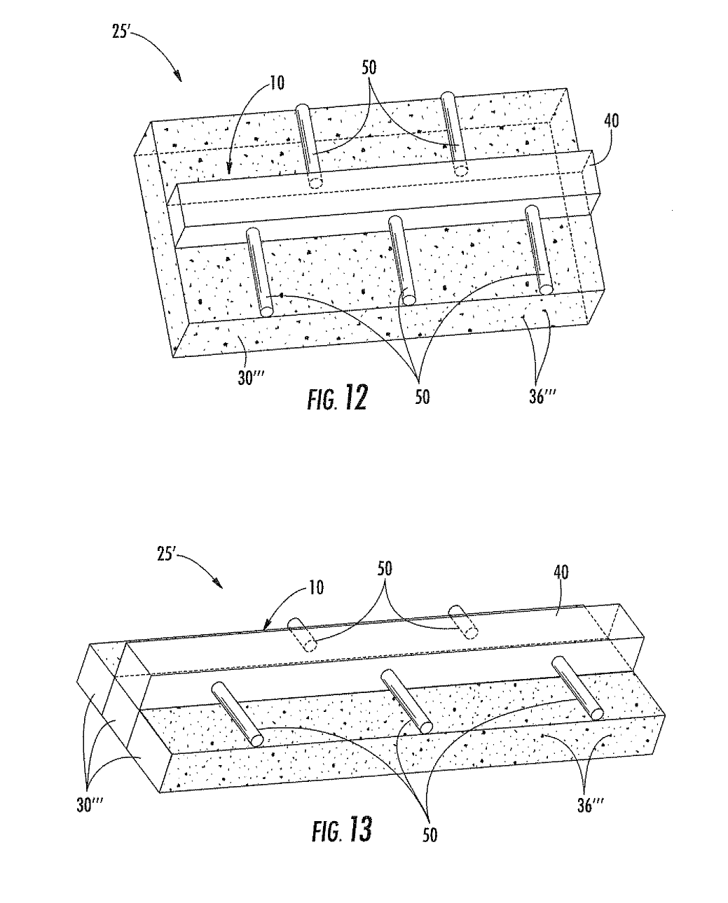

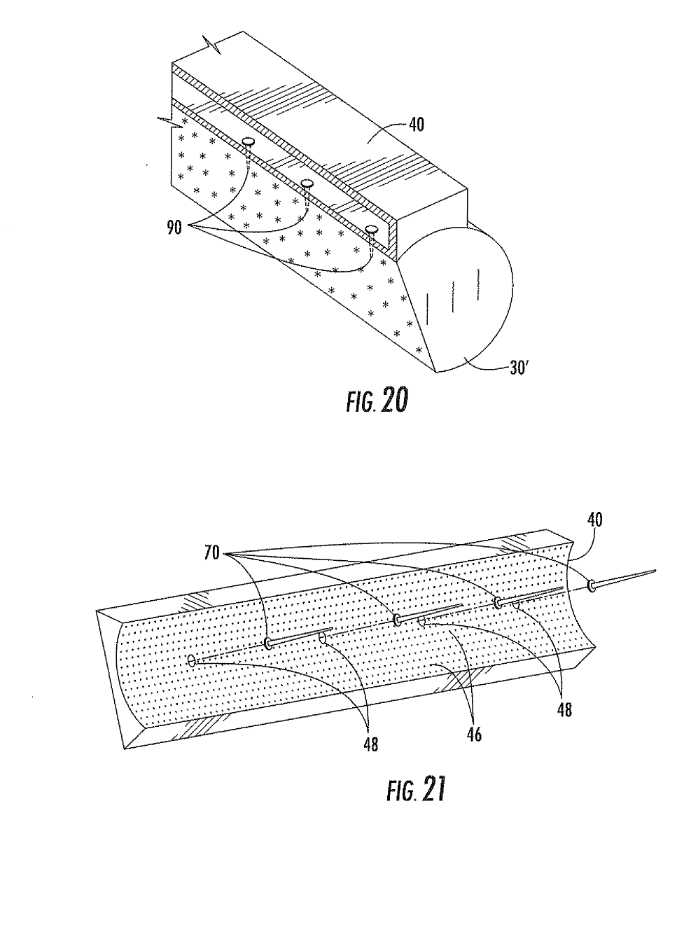

Regarding FIG. 2, the distribution grid 10 is constructed with a flat bottom surface so as to remain relatively stable atop the filter media 944. (See, for example, FIGS. 12 and 13.) The distribution grid 10 is optionally anchored atop the filter media 944 using studs 70, 90. (See, for example, FIGS. 17, 19, 20, 22, and 23).

FIGS. 3-6 and 17-23 show another preferred embodiment in which a distribution grid 10, in accordance with the present invention, is used in conjunction with a system like an MEU 932 that employs preassembled filter media 30 to treat wastewater such as household effluent. (See FIG. 3.) The present embodiment envisions the preassembled filter media 30 to be like the preassembled EPS-netted cylinders 30′ disclosed in U.S. Pat. No. 5,015,123 (“Patent '123”), incorporated here by reference. (In patent '123, the preassembled EPS-netted cylinders are identified by reference number “30,” described and illustrated in FIG. 3, and additionally shown in FIGS. 4A-4C, 5, and 6). Application '305 identifies an alternate construction of the MEU 932 in which four courses of stacked preassembled EPS-netted cylinders 30′ are used. (This version of the MEU 932 is shown in FIG. 12 of application '305. As noted earlier, in application '305 the MEU 932 is referred to as an “MRU”).

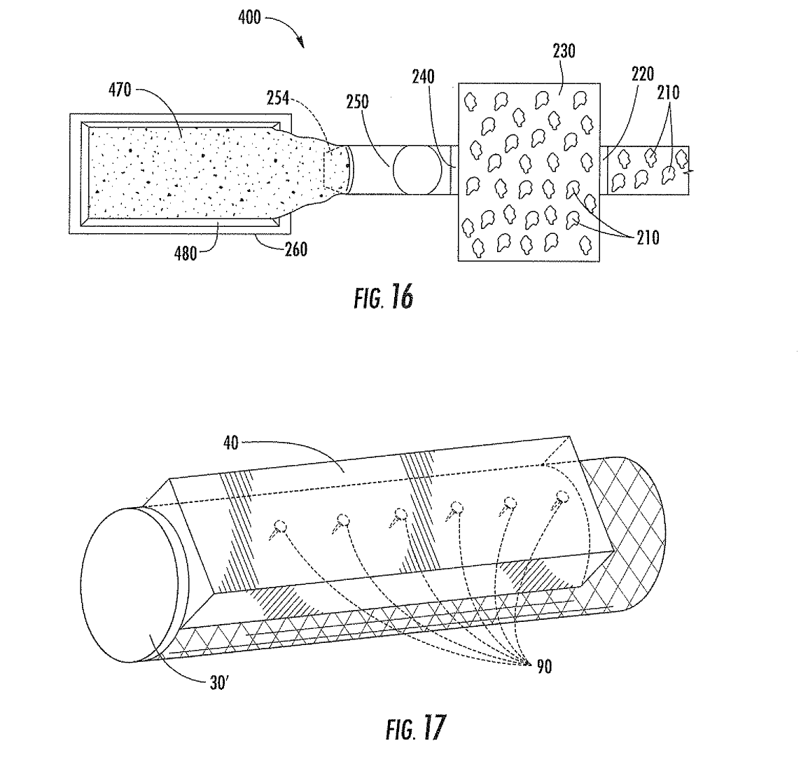

Although the present preferred embodiment envisions an MEU 932 that employs this configuration of EPS-netted cylinders 30′ (see FIG. 3), it is to be recognized that alternate embodiments envision an MEU 932 employing other configurations of EPS-netted cylinders 30′. For example, an MEU 932 can house more than four courses of stacked EPS-netted cylinders 30′ or fewer than four courses of cylinders 30′, or even just one course of cylinders 30′. An alternate embodiment also envisions an MEU 932 using preassembled filter media 30 like the preassembled EPS-filled paper cylinders 30″ shown in FIG. 15. Another alternate embodiment envisions an MEU 932 using preassembled filter media 30 like the rectangular, preassembled, EPS-filled paper bags 30′″ shown in FIG. 16. Still another alternate embodiment envisions an MEU 932 using preassembled filter media 30 like the rectangular, preassembled, EPS-netted bags mentioned in FIG. 16.

Referring to FIG. 3, an MEU 932 comprises a distribution grid 10, an MEU housing 933, and a plurality of preassembled EPS-netted cylinders 30′. The MEU housing 933 contains four courses of stacked preassembled EPS-netted cylinders 30′. (This configuration is also shown in FIG. 12 of application '305.) The EPS-netted cylinders 30′ fill a large majority of the volume of the MEU housing 933, leaving space at the top of the housing 933 for the distribution grid 10. The EPS-netted cylinders 30′ are used to filter effluent and serve as an alternative to traditional filter media 944 (see FIG. 2). The distribution grid 10 is positioned generally horizontally atop the upper surface of a topmost course of the EPS-netted cylinders 30′. The distribution grid 10 spans the upper surface of this topmost course of cylinders 30′. A conduit 20 connects to the distribution grid 10 that is housed within the MEU housing 933. (See FIGS. 4 and 5 for details.) Effluent flows through the conduit 20 into the distribution grid 10. Once inside the distribution grid 10, the effluent continues to flow throughout the span of the distribution grid 10, draining out of perforations 46, 56 (see FIGS. 6 and 18) in the distribution grid 10 onto the EPS-netted cylinders 30′ beneath. Impurities are left behind in the EPS-netted cylinders 30′ as the effluent drains down through the cylinders 30′ toward the bottom of the MEU housing 933. When the effluent reaches the bottom of the MEU housing 933, the effluent drains into a drainage unit 960. The effluent then flows through the drainage unit 960 and into and through other elements of the system until the cleansed effluent eventually reaches the water table, as described earlier in FIG. 1.

Referring to FIGS. 4 and 5, a distribution grid 10 comprises a primary distribution member 40, a plurality of lateral distribution arms 50, and a pipe adaptor 60. A conduit 20 connects to the distribution grid 10 by way of the pipe adaptor 60. The pipe adaptor 60 comprises a connector end 62 and a base end 64. A connector end 62 of the pipe adaptor 60 connects to a proximal end of the conduit 20 while a base end 64 of the pipe adaptor 60 fits onto a front end of the primary distribution member 40 nearest the conduit 20. The lateral distribution arms 50 are connected to the longitudinal sides of the distribution member 40. Some number of the lateral distribution arms 50 are connected to one side of the member 40 with the remaining arms 50 connected to the opposing side of the member 40. The distribution arms 50 are oriented laterally to the distribution member 40 and lie in the same plane. (Note that it is conceivable that in an alternate embodiment the lateral distribution arms 50 will be connected to only one side of the distribution member 40.) The conduit 20 conveys effluent from a septic tank 15 (see FIG. 2) into the primary distribution member 40. From there, the effluent flows throughout the distribution member 40 and into the connected lateral distribution arms 50. The effluent drains out through perforations 46, 56 (see FIGS. 6 and 18) in both the bottom surface of the primary distribution member 40 and the bottom surfaces of the lateral distribution arms 50 onto the preassembled EPS-netted cylinders 30′ (see FIG. 4) beneath. Effluent continues to drain downward through each course of EPS-netted cylinders 30 until it reaches the bottom of the MEU housing 933. (See FIG. 3.) In this way, the distribution grid 10 distributes effluent over the EPS-netted cylinders 30′, thereby providing for efficient cleansing of the effluent.

Still referring to FIGS. 4 and 5, the present embodiment envisions three lateral distribution arms 50 extending from a first longitudinal side of the distribution member 40 and two lateral distribution arms 50 extending from a second opposing longitudinal side of the distribution member 40. The three distribution arms 50 on the first side of the distribution member 40 are positioned generally equidistant from one another, with the three arms 50 being spaced along a majority of the length of the first side of the member 40 and the middle of the three arms 50 positioned generally in the center of the first side of the distribution member 40. A first lateral distribution arm 50 on the second side of the primary distribution member 40 is positioned across from the approximate center of the area that appears between the middle of the three arms 50 on the opposing first side of the member 40 and the arm 50 nearest the pipe adaptor 60 on the opposing first side of the member 40. The second lateral distribution arm 50 on the second side of the primary distribution member 40 is positioned across from the approximate center of the area that appears between the middle of the three arms 50 on the opposing first side of the member 40 and the arm 50 furthest from the pipe adaptor 60 on the opposing first side of the member 40. The lateral distribution arms 50 are connected to the distribution member 40 by snapping the distribution arms 50 into the longitudinal sides of the distribution member 40. Alternate embodiments contemplate different methods for connecting the distribution arms 50 to the primary distribution member 40.

Regarding FIGS. 4 and 5, alternate embodiments envision a greater or fewer number of distribution arms 50 connected to a distribution member 40, and in a different arrangement. For example, a primary distribution member 40 might have three lateral distribution arms 50 connected to each longitudinal side of the distribution member 40, with the arms 50 in each pair of opposing distribution arms 50 positioned directly across from each other. Another alternate embodiment envisions a distribution member 40 with no lateral distribution arms 50 connected to the primary distribution member 40.

Referring now to FIG. 4, a distribution grid 10 is positioned generally horizontally atop preassembled EPS-netted cylinders 30′. A primary distribution member 40 of the distribution grid 10 resides directly atop one of the EPS-netted cylinders 30′ so that the bottom surface of the primary distribution member 40 is adjacent to the upper surface of the EPS-netted cylinder 30′. The bottom surface of the distribution member 40 is contoured in a concave shape that approximates the curvature of the outer surface of the EPS-netted cylinder 30′. (See particularly FIGS. 17 and 19.) This permits the primary distribution member 40 to reside atop the EPS-netted cylinder 30′ in a relatively stable manner. Alternate embodiments envision a primary distribution member 40 with a generally flat bottom surface so as to reside in a relatively stable manner atop types of filter media 30, 944 that have a generally flat upper surface. (See, for example, FIGS. 12 and 13.) The primary distribution member 40 is the same general length as the EPS-netted cylinder 30′ atop which the member 40 resides and, given that the distribution member 40 is contoured to reside atop the cylinder 30′ in a relatively stable manner, the distribution member 40 is approximately the same width as the EPS-netted cylinder 30′ as well.

Regarding FIG. 4, in alternate embodiments the shape and dimensions of the primary distribution member 40 will be dictated, in part, by the type of filter media 30, 944 with which it is used. Regarding preassembled filter media 30, the shapes and dimensions of the primary distribution member 40 will also be dictated, in part, by the dimensions of the filter media 30. (Note that the shape and dimensions of a pipe adaptor 60 and of lateral distribution arms 50 will, themselves, be dictated in part by the shape and dimensions of the primary distribution member 40 so as to ensure that the entire distribution grid 10 is capable of working as a functional unit).

Referring to FIG. 18, the bottom surface of a primary distribution member 40 contains a plurality of perforations 46. As effluent flows through the distribution member 40, the effluent drains out of the perforations 46 onto the EPS-netted cylinders 30′ (see FIG. 4) beneath. The effluent that fails to drain out of the perforations 46 in the primary distribution member 40 flows into the connected lateral distribution arms 50 (see FIG. 4). In an alternate embodiment, the primary distribution member 40 does not contain perforations 46.

Referring to FIG. 10, the bottom surface of a lateral distribution arm 50 contains a plurality of perforations 56. As effluent flows along the distribution arm 50, the effluent drains out of the perforations 56 onto the EPS-netted cylinders 30′ (see FIG. 4) beneath. It should be noted that the length of lateral distribution arms 50 will be dictated, in part, by the width of the overall surface of an expanse of filter media 30. (See FIG. 3.) In certain applications, the lateral distribution arms 50 might need to be longer to cover filter media 30 with a wider overall expanse. In other applications, the lateral distribution arms might need to be shorter to cover filter media 30 with a narrower overall expanse.

Referring again to FIG. 18, the bottom surface of a primary distribution member 40 contains a plurality of retainer holes 48. The retainer holes 48 are used for attaching a plurality of stability studs 90 to the bottom surface of the distribution member 40. The retainer holes 48 are aligned longitudinally along the approximate center of the bottom surface of the primary distribution member 40. The retainer holes 48 are generally equally spaced one from another. The head of each stability stud 90 snaps into a retainer hole 48. Once attached, the stability studs 90 remain secured to the bottom surface of the distribution member 40. In an alternate embodiment, other means for attaching stability studs 90 to the distribution member 40 are envisioned. In another alternate embodiment, the stability studs 90 are part of the primary distribution member 40 itself and not separate elements. In still another alternate embodiment, stability studs 90 are not used with a primary distribution member 40 at all, and the distribution member 40 may or may not contain retainer holes 48.

Referring to FIGS. 17, 19, and 20, a plurality of stability studs 90 are used to secure a primary distribution member 40 to a preassembled EPS-netted cylinder 30′. The heads of the stability studs 90 are attached securely to the bottom surface of the primary distribution member 40, as described earlier in FIG. 18. The stability stud 90 is tapered such that the distal end of each stability stud 90 narrows to somewhat of a point. The pointed, distal end of each stability stud 90 is driven into the upper surface of the EPS-netted cylinder 30′, in a generally perpendicular orientation to the upper surface of the cylinder 30′, until the bottom surface of the distribution member 40 is brought into contact with the upper surface of the EPS-netted cylinder 30′. In this way, the stability studs 90 help to hold the distribution member 40 securely in place. Given the nature of the EPS media that makes up the preassembled EPS-netted cylinder 30′, the stability studs 90 drive relatively easily into the EPS-netted cylinder 30′. The pointed, distal ends of the stability studs 90 are not long enough to protrude through the bottom of the EPS-netted cylinder 30′; consequently, the distal ends of the stability studs 90 remain embedded within the EPS-netted cylinder 30′.

Regarding FIGS. 17, 19, and 20, in an alternate embodiment a distribution grid 40 and preassembled filter media 30, such as EPS-netted cylinders 30′, are buried together beneath backfill material. In this embodiment, the additional stability provided by the stability studs 90 can be particularly beneficial.

Referring to FIGS. 21-23, as an alternative to stability studs 90, elongated stability studs 70 can be used with a primary distribution member 40 to hold the distribution member 40 in place atop a preassembled EPS-netted cylinder 30′.

Referring to FIG. 21, retainer holes 48 in the bottom surface of a primary distribution member 40 are used for attaching a plurality of elongated stability studs 70 to the distribution member 40. The head of each elongated stability stud 70 snaps into a retainer hole 48. Once attached, the elongated stability studs 70 remain secured to the bottom surface of the distribution member 40.

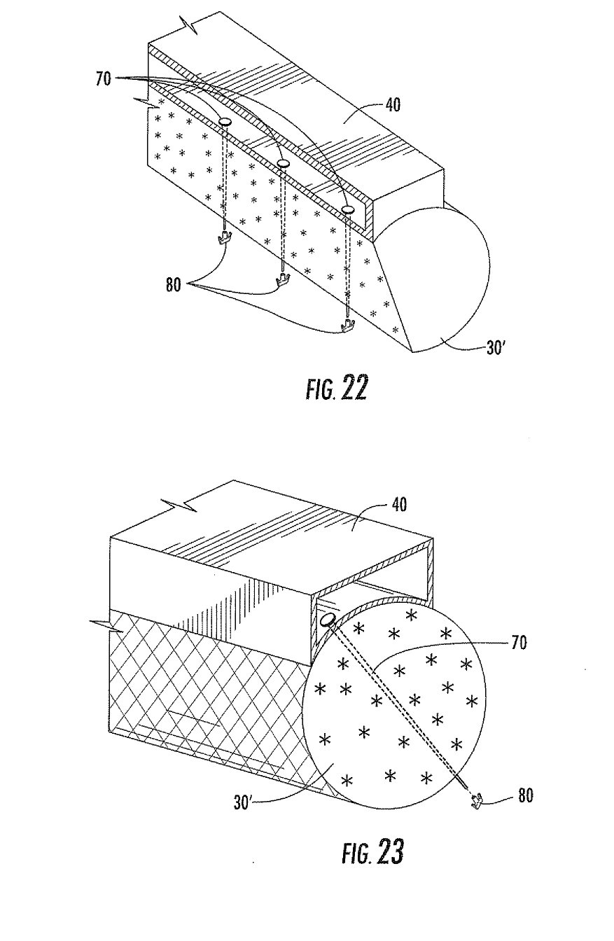

Referring to FIGS. 22 and 23, a plurality of elongated stability studs 70 are used to secure a primary distribution member 40 to a preassembled EPS-netted cylinder 30′. The heads of the elongated stability studs 70 are attached securely to the bottom surface of the primary distribution member 40, as shown in FIG. 21. The elongated stability stud 70 is tapered such that the distal end of each elongated stability stud 70 narrows to somewhat of a point. The pointed, distal end of each elongated stability stud 70 is driven into the upper surface of the EPS-netted cylinder 30′, in a generally perpendicular orientation to the upper surface of the cylinder 30′, until the bottom surface of the distribution member 40 is brought into contact with the upper surface of the EPS-netted cylinder 30′. In this way, the elongated stability studs 70 help to hold the distribution member 40 securely in place. As with the stability studs 90 described in FIGS. 17, 19, and 20, the elongated stability studs 70 drive relatively easily into the EPS-netted cylinder 30′. The elongated stability studs 70 are longer than the diameter of the EPS-netted cylinder 30′; consequently, the distal ends of the elongated stability studs 70 protrude through the bottom surface of the cylinder 30′. A retainer cap 80 attaches snugly over the distal end of each elongated stability stud 70 to secure the stud 70 in place. The present embodiment envisions the retainer cap 80 snapping onto the end of the stud 70. An alternate embodiment envisions other means for attaching a retainer cap 80 to an elongated stability stud 70. Another alternate embodiment envisions means for securing the end of an elongated stability stud 70 to an EPS-netted cylinder 30′ without the use of a retainer cap 80.

Regarding FIGS. 22 and 23, as with the stability studs 90 described earlier in FIGS. 17, 19, and 20, in an alternate embodiment a distribution grid 40 and preassembled filter media 30, such as EPS-netted cylinders 30′, are buried together beneath backfill material. In this embodiment, the additional stability provided by the elongated stability studs 70 can be particularly beneficial.

FIGS. 7-9 show alternate configurations in which multiple MEUs 932 are employed to treat wastewater, such as household effluent. Multiple MEUs 932 will need to be employed in some instances where the constraint on available land is great, where the volume of wastewater to be treated is high, or where both factors are extant. The alternate configurations shown in FIGS. 7-9 are in accord with the preferred embodiment shown in FIG. 2, the preferred embodiment shown in FIGS. 3-6 and 17-23, and all compatible alternate embodiments not specifically shown.

Referring to FIG. 7, an alternate configuration comprises a plurality of incoming conduits 20 and a plurality of MEUs 932. Each MEU 932 comprises a distribution grid 10, among other elements. The distribution grid 10, in turn, comprises a primary distribution member 40, a plurality of lateral distribution arms 50, and a pipe adaptor 60. Each incoming conduit 20 connects to a distribution grid 10 (housed within an MEU 932) by way of a pipe adaptor 60. The pipe adaptor 60 comprises a connector end 62 and a base end 64. A connector end 62 of a first pipe adaptor 60 connects to a proximal end of a first incoming conduit 20 while a base end 64 of the first pipe adaptor 60 fits onto a front end of a first primary distribution member 40 nearest the incoming conduit 20. For each subsequent incoming conduit 20, a connector end 62 of a subsequent pipe adaptor 60 connects to a proximal end of the subsequent conduit 20 while a base end 64 of the subsequent pipe adaptor 60 fits onto a front end of a subsequent primary distribution member 40 nearest the incoming conduit 20. Connections continue in this way for as many MEUs 932 as are to be connected to unconnected, incoming conduits 20.

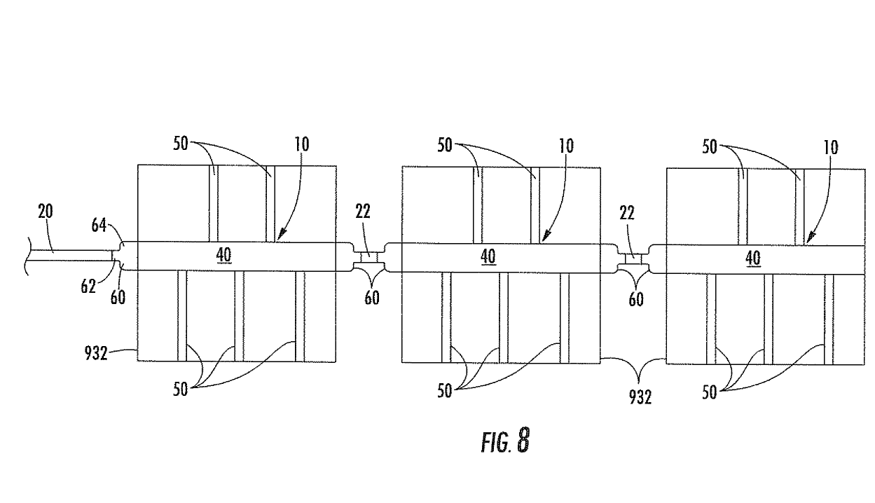

Referring to FIG. 8, another alternate configuration comprises an incoming conduit 20, a plurality of connector conduits 22, and a plurality of MEUs 932. Each MEU 932 comprises a distribution grid 10, among other elements. The distribution grid 10, in turn, comprises a primary distribution member 40, a plurality of lateral distribution arms 50, and a plurality of pipe adaptors 60. Note that to connect a first MEU 932 to a second MEU 932 requires that a first distribution grid 10 (housed within the first MEU 932) be comprised of two pipe adaptors 60 instead of just one pipe adaptor 60. A first pipe adaptor 60 will be used to connect the first distribution grid 10 to the incoming conduit 20 while a second pipe adaptor 60 will be used to connect the first distribution grid 10 to a first connector conduit 22. The first connector conduit 22 will be connected, in turn, to a second distribution grid 10 (housed within the second MEU 932) by way of a third pipe adaptor 60. This third pipe adaptor 60 is an element of the second distribution grid 10. If the second MEU 932 is to be connected to a third MEU 932, then a fourth pipe adaptor 60 will be used to connect the second distribution grid 10 to a second connector conduit 22. The second connector conduit 22 will be connected, in turn, to a third distribution grid 10 (housed within the third MEU 932) by way of a fifth pipe adaptor 60. This fifth pipe adaptor 60 is an element of the third distribution grid 10. If the third MEU 932 is not to be connected to any other MEUs 932, then the third distribution grid 10 will be comprised of only this one pipe adaptor 60, the fifth pipe adaptor 60.

Continuing with FIG. 8, specific details of how multiple MEUs 932 are connected to one incoming conduit 20 and to each other are now given. A pipe adaptor 60 comprises a connector end 62 and a base end 64. An incoming conduit 20 connects to a first distribution grid 10 (housed within a first MEU 932) by way of a first pipe adaptor 60. A connector end 62 of the first pipe adaptor 60 connects to a proximal end of the incoming conduit 20 while a base end 64 of the first pipe adaptor 60 fits onto a front end of a first primary distribution member 40 nearest the incoming conduit 20. A base end 64 of a second pipe adaptor 60 connects to an opposing rear end of the first distribution member 40 while a connector end 62 of the second pipe adaptor 60 connects to a proximal end of a first connector conduit 22. At this point, one end of the first distribution grid 10 has been connected to the incoming conduit 20 while the opposing end of the first distribution grid 10 has been connected to the first connector conduit 22. An opposing end of the first connector conduit 22 will now be used to connect to a second distribution grid 10 (housed within a second MEU 932) using a second primary distribution member 40 and a third pipe adaptor 60, both of which are elements of the second distribution grid 10. A connector end 62 of the third pipe adaptor 60 connects to the opposing end of the first connector conduit 22. A base end 64 of the third pipe adaptor 60 connects to a front end of the second primary distribution member 40 nearest the incoming conduit 20. A base end 64 of a fourth pipe adaptor 60 connects to an opposing rear end of the second distribution member 40. A connector end 62 of the fourth pipe adaptor 60 connects to a proximal end of a second connector conduit 22. At this point, one end of the second distribution grid 10 has been connected to the first connector conduit 22 while the opposing end of the second distribution grid 10 has been connected to the second connector conduit 22. An opposing end of the second connector conduit 22 is now ready to be connected to a subsequent distribution grid 10 (housed within a subsequent MEU 932). Connections continue in this way for as many subsequent, unconnected MEUs 932 as are to be connected by a connector conduit 22 to a previous connected MEU 932.

Still referring to FIG. 8, note that the final distribution grid 10 in a series of connected distribution grids 10 will require only one pipe adaptor 60. This one final pipe adaptor 60 will be used to connect the front end of a final primary distribution member 40 of the final distribution grid 10 to a remaining unconnected end of a final connector conduit 22. The opposing end of the final connector conduit 22 will have been previously connected to the previous distribution grid 10.

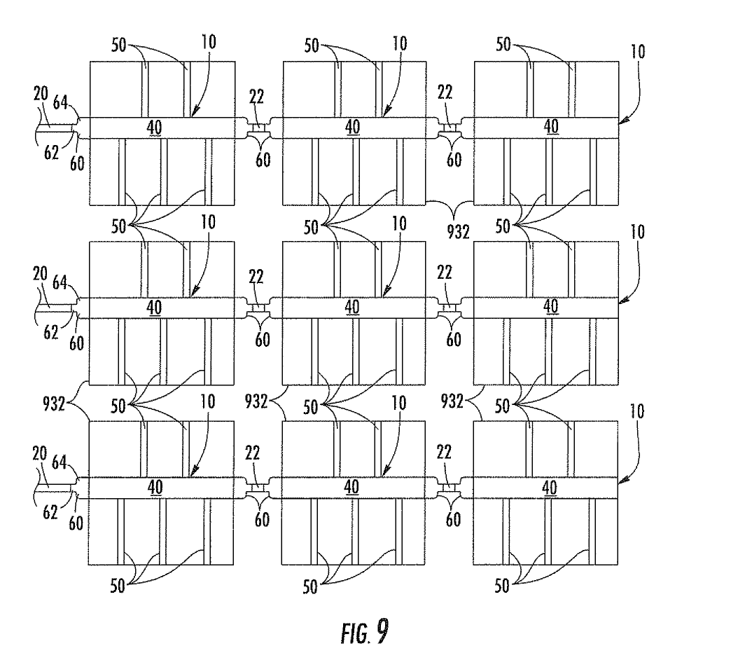

Referring to FIG. 9, another alternate configuration comprises a plurality of incoming conduits 20, a plurality of connector conduits 22, and a plurality of MEUs 932. Each MEU 932 comprises a distribution grid 10, among other elements. Each incoming conduit 20 connects to a first MEU 932 by way of a first distribution grid 10 that is housed within the first MEU 932, as described in FIG. 7. For each first MEU 932 connected to an incoming conduit 20, a second MEU 932 connects to the first MEU 932, as described in FIG. 8. With the connection of the first MEU 932 to the second MEU 932, a series of connected MEUs 932 has been established. Each subsequent MEU 932 in the series of connected MEUs 932 connects to a previous MEU 932 in the series, terminating with a final MEU 932, as described in FIG. 8. No subsequent MEUs 932 connect to the final MEU 932 in the series. In this way, each incoming conduit 20 is connected to a series of MEUs 932. Note, however, that in some applications there may be only one MEU 932 connected to a given incoming conduit 20, rather than a series of connected MEUs 932.

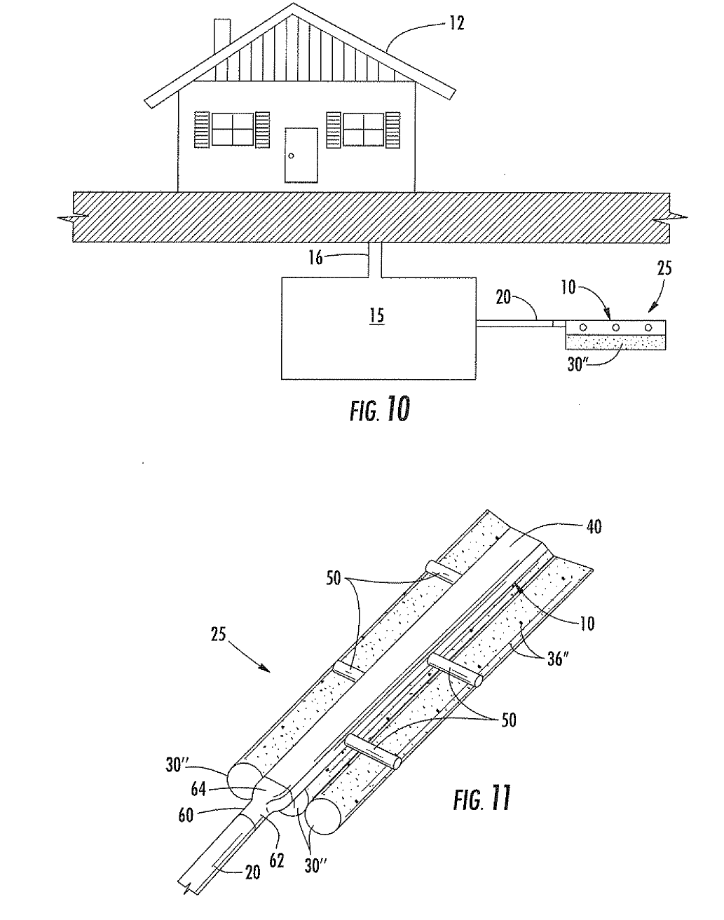

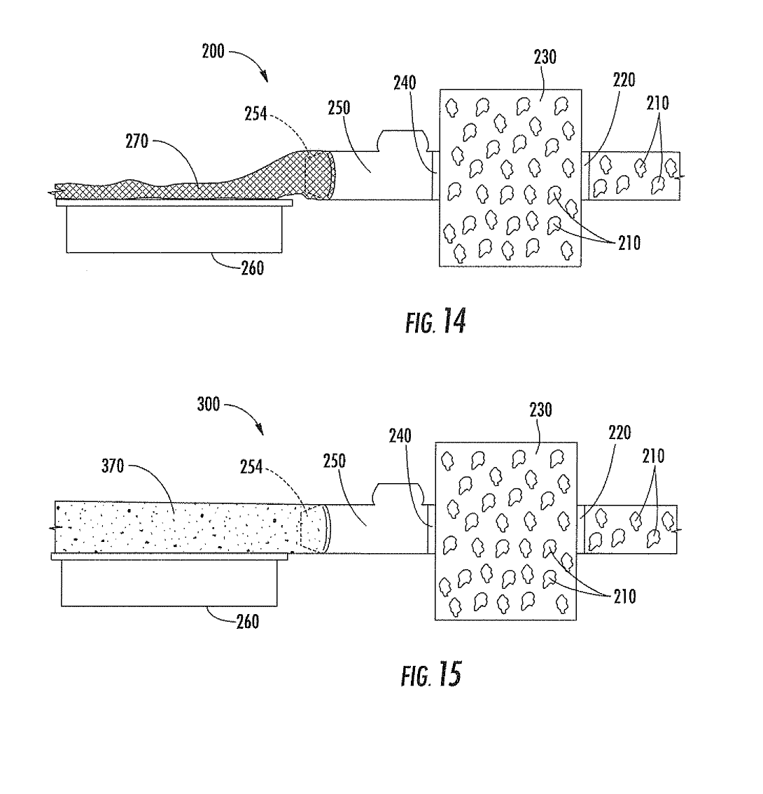

FIGS. 10 and 11 show another preferred embodiment in which a drainfield 25, in accordance with the present invention, is used to treat wastewater such as household effluent. The drainfield 25 comprises a distribution grid 10 and a plurality of preassembled filter media 30. The present embodiment envisions the preassembled filter media 30 to be like those EPS-filled paper cylinders 30″ shown in FIG. 15. The present embodiment also envisions the preassembled filter media 30 to be configured as one course of three EPS-filled paper cylinders 30″ positioned side by side, with each cylinder 30″ parallel to the other cylinders 30″. (See FIG. 11.) Alternate embodiments employ other configurations of EPS-filled paper cylinders 30″, such as two courses of stacked EPS-filled paper cylinders 30″ with each course made up of three cylinders 30″, or one course of four EPS-filled paper cylinders 30″. Another alternate embodiment envisions a distribution grid 10 used in conjunction with preassembled filter media 30 like the EPS-netted cylinders 30′ shown in FIG. 14.

Referring to FIG. 10, effluent flows from a household 12 into an underground septic tank 15 through an underground household effluent pipe 16. The effluent is initially treated in the septic tank 15 before flowing out of the septic tank 15, through a conduit 20, and into an underground drainfield 25. In some systems, a distribution/filtration subsystem is interposed between the septic tank 15 and the drainfield 25. In these systems, the distribution/filtration subsystem performs some initial treatment of the effluent flowing from the septic tank 15 to remove portions of biomass, bacteria, and the like.

Referring to FIG. 1, a drainfield 25 comprises a distribution grid 10 and a plurality of preassembled EPS-filled paper cylinders 30″. The present embodiment envisions the drainfield 25 comprising three EPS-filled paper cylinders 30″. The three cylinders 30″ are positioned side by side, with each cylinder 30″ generally parallel to the other two cylinders 30″. The distribution grid 10 is positioned generally horizontally atop the EPS-filled paper cylinders 30″, with the distribution grid 10 spanning the upper surfaces of the cylinders 30″. The distribution grid 10 comprises a primary distribution member 40, a plurality of lateral distribution arms 50, and a pipe adaptor 60. The primary distribution member 40 is positioned atop the middle of the three EPS-filled paper cylinders 30″ and optionally secured there using studs 70, 90. (See FIGS. 17, 19, 20, 22, and 23.) A conduit 20 connects to the distribution grid 10 by way of the pipe adaptor 60. The pipe adaptor 60 comprises a connector end 62 and a base end 64. The connector end 62 of the pipe adaptor 60 connects to a proximal end of the conduit 20 while a base end 64 of the pipe adaptor 60 fits onto a front end of the primary distribution member 40 nearest the conduit 20. The present embodiment envisions three lateral distribution arms 50 extending from a first longitudinal side of the distribution member 40 and two lateral distribution arms 50 extending from a second opposing longitudinal side of the member 40. The lateral distribution arms 50 are configured as described in FIGS. 4 and 5. Alternate embodiments envision a greater or fewer number of lateral distribution arms 50 connected to a distribution member 40, and in a different arrangement. Another alternate embodiment envisions a primary distribution member 40 with no lateral distribution arms 50 connected to the distribution member 40.

Continuing with FIG. 11, effluent flows through the conduit 20 into the distribution grid 10. Once inside the distribution grid 10, the effluent continues to flow throughout the span of the grid 10, draining out through perforations 46, 56 (see FIGS. 6 and 18) in the bottom surface of the primary distribution member 40 and the bottom surfaces of the lateral distribution arms 50 onto the EPS-filled paper cylinders 30″ beneath. The EPS-filled paper cylinders 30″ contain perforations 36″ that accept effluent leaked down onto the paper cylinders 30″. Impurities are left behind in the EPS-filled paper cylinders 30″ as the effluent drains down through the cylinders 30″ toward the soil beneath. Note that in an alternate embodiment, the primary distribution member 40 does not contain perforations 46.

Note in addition that the paper skin of the preassembled EPS-filled paper cylinders 30″ functions as built-in barrier material. The paper skin of the EPS-filled paper cylinders 30″ eliminates the need for inclusion of geotextile fabric or similar products in some drainfield installations. Note further that although FIGS. 10 and 11 show the use of a single distribution grid 10, the present preferred embodiment contemplates instances in which multiple distribution grids 10 will be used instead. In such instances, alternate configurations similar to those shown in FIGS. 7-9 are envisioned. (The major difference between the alternate configurations contemplated by the present preferred embodiment and the alternate configurations shown in FIGS. 7-9 is, of course, that the present embodiment does not employ MEUs 932 like those shown in FIGS. 7-9).

FIGS. 12 and 13 show another preferred embodiment in which an underground drainfield 25′, in accordance with the present invention, is used to treat wastewater such as household effluent. The underground drainfield 25′ comprises a distribution grid 10 and filter media 30, 944 that has a generally flat upper surface. The filter media 30, 944 can be preassembled filter media 30 or traditional filter media 944. The present embodiment envisions using one or more rectangular, preassembled, EPS-filled paper bags 30′″ like those shown in FIG. 16. The number of preassembled, EPS-filled paper bags 30′″ required for the drainfield 25′ depends upon the dimensions of the EPS-filled paper bags 30′″ used. FIG. 12 shows a first version of the preferred embodiment in which a single preassembled, EPS-filled paper bag 30′″ is used in the drainfield 25′. FIG. 13 shows a second version of the preferred embodiment in which three narrower preassembled, EPS-filled paper bags 30′″ are used in the drainfield 25′. An alternate embodiment envisions a drainfield 25′ comprising one or more units of preassembled filter media 30 like the rectangular, preassembled, EPS-netted bags mentioned in FIG. 16. Another alternate embodiment envisions a drainfield 25′ comprising traditional filter media 944, such as the filter media 944 shown in FIG. 2.

Referring to FIG. 12, an underground drainfield 25′ comprises a distribution grid 10 and a preassembled, EPS-filled paper bag 30′″. The distribution grid 10 is positioned generally horizontally atop the upper surface of the EPS-filled paper bag 30′″, with the distribution grid 10 spanning the upper surface of the EPS-filled paper bag 30′″. The distribution grid 10 comprises a primary distribution member 40, a plurality of lateral distribution arms 50, and a pipe adaptor 60 (not shown). (See FIGS. 4 and 5 for details.) The primary distribution member 40 has a generally flat bottom surface, which allows the distribution member 40 to reside atop the preassembled, EPS-filled paper bag 30′″ in a relatively stable manner. The primary distribution member 40 is positioned lengthwise atop the EPS-filled paper bag 30′″ such that one end of the distribution member 40 is generally aligned with one edge of the EPS-filled paper bag 30′″ while the opposing end of the distribution member 40 is generally aligned with the opposing edge of the EPS-filled paper bag 30′″ and such that the distribution member 40 is positioned in the approximate center of the EPS-filled paper bag 30′″. The primary distribution member 40 is optionally anchored atop the EPS-filled paper bag 30′″ using studs 70, 90. (See, for example, FIGS. 17, 19, 20, 22, and 23.) The lateral distribution arms 50 extend from either side of the distribution member 40 and are configured as described in FIGS. 4 and 5. The distal end of each distribution arm 50 aligns with a respective edge of the EPS-filled paper bag 30′″ such that the distribution grid 10, as a whole, spans the upper surface of the EPS-filled paper bag 30′″. The EPS-filled paper bag 30′″ contains perforations 36′″ so as to accept effluent leaked down onto the paper bag 30′″ through the perforations 46, 56 (see FIGS. 6 and 18) in the bottom surface of the primary distribution member 40 and the bottom surfaces of the lateral distribution arms 50.

Continuing with FIG. 12, effluent flows into the distribution grid 10 from a septic tank 15. (See, for example, FIG. 10.) Once inside the distribution grid 10, the effluent continues to flow throughout the span of the grid 10, draining out through perforations 46, 56 (see FIGS. 6 and 18) in the distribution grid 10 onto the BPS-filled paper bag 30′″ below. Impurities are left behind in the EPS-filled paper bag 30′″ as the effluent drains down through the EPS-filled paper bag 30′″ toward the soil beneath.

Regarding FIG. 12, in alternate embodiments an underground drainfield 25′ comprises a plurality of preassembled, EPS-filled paper bags 30′″ of the size shown in FIG. 12. In some of these alternate embodiments, EPS-filled paper bags 30′″ lie atop one another. In other of these alternate embodiments, the EPS-filled paper bags 30′″ lie side by side. In still other of these alternate embodiments, a plurality of EPS-filled paper bags 30′″ lie both side by side and atop one another.

FIG. 13 shows a second version of the present embodiment in which an underground drainfield 25′ uses multiple preassembled, EPS-filled paper bags 30′″ rather than just one EPS-filled paper bag 30′″. Specifically, this version of the present embodiment envisions the drainfield 25′ using three EPS-filled paper bags 30′″. The three EPS-filled paper bags 30′″ are configured as one course of EPS-filled paper bags 30′″ positioned side by side, with each EPS-filled paper bag 30′″ generally parallel to the other two EPS-filled paper bags 30′″. The distribution grid 10 is positioned generally horizontally atop the EPS-filled paper bags 30′″, with the distribution grid 10 spanning the upper surfaces of the EPS-filled paper bags 30′″. The primary distribution member 40 is positioned atop the middle of the three EPS-filled paper bags 30′″. The primary distribution member 40 is optionally anchored to the EPS-filled paper bag 30′″ using studs 70, 90. (See FIGS. 17, 19, 20, 22, and 23.) Alternate embodiments employ other configurations of EPS-filled paper bags 30′″, such as two courses of stacked EPS-filled paper bags 30′″ with each course made up of three EPS-filled paper bags 30′″, or one course of four EPS-filled paper bags 30′″.

Note that the present preferred embodiment of an underground drainfield 25′ utilizing preassembled EPS-filled paper bags 30′″ is well suited to dig out installations wherein a quantity of soil has been excavated and would normally be replaced with soil of better drainage quality. Note in addition that the paper skin of the preassembled EPS-filled paper bags 30′″ functions as built-in barrier material. The paper skin of the EPS-filled paper bags 30′″ eliminates the need for inclusion of geotextile fabric or similar products in some drainfield installations. Note further that although FIGS. 12 and 13 show the use of a single distribution grid 10, the present preferred embodiment contemplates instances in which multiple distribution grids 10 will be used instead. In such instances, alternate configurations similar to those shown in FIGS. 7-9 are envisioned. (The major difference between the alternate configurations contemplated by the present preferred embodiment and the alternate configurations shown in FIGS. 7-9 is, of course, that the present embodiment does not employ MEUs 932 like those shown in FIGS. 7-9).

FIG. 14 shows another preferred embodiment in which a method and apparatus 200 is used to manufacture preassembled EPS-netted cylinders 30′, in accordance with the present invention.

Referring to FIG. 14, a volume chamber 230 accepts a supply of aggregate 210 through a secondary gate 220. The present embodiment envisions the aggregate 210 comprising pieces of EPS media. Alternate embodiments employ other types of aggregate 210, such as pieces of styrene, Styrofoam, and certain recycled plastics. When the secondary gate 220 opens it creates a space through which aggregate 210 can enter the volume chamber 230. A predetermined quantity of aggregate 210 is then drawn into the chamber 230. The predetermined quantity of aggregate 210 may be the quantity required to fill the chamber 230 or the quantity of aggregate 210 may be some lesser amount. At this point, the secondary gate 220 closes and a primary gate 240 opens. When the primary gate 240 opens it creates a space through which the aggregate 210 can be drawn. A blower 250 draws all of the aggregate 210 out of the volume chamber 230 and into a length of sleeve netting 270 (discussed later). The primary gate 240 then closes. At this point, the secondary gate 220 opens again allowing the volume chamber 230 to be refilled with a predetermined quantity of aggregate 210.

Continuing with FIG. 14, while the primary gate 240 is closed, a length of sleeve netting 270 is drawn along a slide table 260 until the mouth of the sleeve netting 270 is brought into position over the blower exhaust outlet 254. The mouth of the netting 270 is then secured there. A distal end of the netting 270 is cut at a measured point. This ensures that the netting 270 is of a predetermined length that ensures the predetermined quantity of aggregate 210 will fill the length of netting 270 to a desired level. The distal end of the netting 270 that was just cut is tied off. When the primary gate 240 opens, the blower 250 draws a predetermined quantity of aggregate 210 out of the volume chamber 230 and into the sleeve netting 270, filling it to the desired level. When the primary gate 240 closes, the mouth of the netting 270 is removed from the blower exhaust outlet 254 and tied off. The filled netting 270 is now a completed preassembled EPS-netted cylinder 30′. The EPS-netted cylinder 30′ is removed from the slide table 260 and a new length of sleeve netting 270 is drawn forward along the table 260 until the mouth of the sleeve netting 270 is brought into position over the blower exhaust outlet 254. The next preassembled EPS-netted cylinder 30′ is now ready to be constructed.

Regarding FIG. 14, note that preassembled EPS-netted cylinders 30′ can be manufactured in various lengths and diameters. The present embodiment envisions manufacturing EPS-netted cylinders 30′ with a diameter from eight inches up to twenty inches. Other diameters are also possible. FIGS. 3 and 4 show a distribution grid 10 used in conjunction with preassembled EPS-netted cylinders 30′ like the EPS-netted cylinders 30′ manufactured by the present preferred embodiment.

FIG. 15 shows another preferred embodiment in which a method and apparatus 300 is used to manufacture preassembled EPS-filled paper cylinders 30″, in accordance with the present invention. The apparatus 200 described in FIG. 14 for manufacturing preassembled EPS-netted cylinders 30′ is generally the same as the apparatus 300 shown in FIG. 15. The method 200 described in FIG. 14 for manufacturing preassembled EPS-netted cylinders 30′ is similar to the method 300 shown in FIG. 15. The major difference between the method 200 in FIG. 14 and the method 300 in FIG. 15 is that the method 300 shown in FIG. 15 is used to manufacture preassembled EPS-filled paper cylinders 30″ comprising perforated paper tubing 370 filled with EPS aggregate 210, whereas the method 200 in FIG. 14 is used to manufacture EPS-netted cylinders 30′.

Referring to FIG. 15, the same basic steps are followed here as are described in FIG. 14. In the present preferred embodiment, however, when a primary gate 240 is closed, a length of perforated paper tubing 370 is drawn along a slide table 260 until the mouth of the paper tubing 370 is brought into position over a blower exhaust outlet 254. The mouth of the paper tubing 370 is then secured there. A distal end of the perforated paper tubing 370 is cut at a measured point. This ensures that the paper tubing 370 is of a predetermined length that ensures a predetermined quantity of aggregate 210 will fill the length of paper tubing 370 to a desired level. The distal end of the perforated paper tubing 370 that was just cut is closed up. When the primary gate 240 opens, a blower 250 draws the predetermined quantity of aggregate 210 out of a volume chamber 230 and into the length of perforated paper tubing 370. The end of the perforated paper tubing 370 is then removed from the blower exhaust outlet 254 and closed up. The filled paper tubing 370 is now a completed preassembled EPS-filled paper cylinder 30″. The EPS-filled paper cylinder 30″ is removed from a slide table 260 and a new length of perforated paper tubing 370 is drawn forward along the slide table 260 until the mouth of the perforated paper tubing 370 is brought into position over the blower exhaust outlet 254. The next preassembled EPS-filled paper cylinder 30″ is now ready to be constructed.

Regarding FIG. 15, note that preassembled EPS-filled paper cylinders 30′″ can be manufactured in various lengths and diameters. The present embodiment envisions manufacturing EPS-filled paper cylinders 30″ with a diameter from eight inches up to twenty inches. Other diameters are also possible. FIGS. 10 and 11 show a drainfield 25 comprising a plurality of preassembled EPS-filled paper cylinders 30″ like the EPS-filled paper cylinders 30″ manufactured by the present preferred embodiment.

FIG. 16 shows another preferred embodiment in which a method and apparatus 400 is used to manufacture rectangular, preassembled, EPS-filled paper bags 30′″, in accordance with the present invention. The apparatus 200 described in FIG. 14 for manufacturing preassembled EPS-netted cylinders 30′ is similar to the apparatus 400 shown in FIG. 16. The major difference between the apparatus 200 in FIG. 14 and the apparatus 400 in FIG. 16 is that the apparatus 400 shown in FIG. 16 employs a jig 480, whereas the apparatus 200 in FIG. 14 does not. The method 200 described in FIG. 14 for manufacturing preassembled EPS-netted cylinders 30′ is also similar to the method 400 shown in FIG. 16. The major difference between the method 200 in FIG. 14 and the method 400 in FIG. 16 is that the method 400 shown in FIG. 16 uses a jig 480 to help manufacture rectangular, preassembled, EPS-filled paper bags 30′″ comprising perforated paper-bag material 470 filled with EPS aggregate 210, whereas the method 200 in FIG. 14 is used to manufacture EPS-netted cylinders 30′ and does not use a jig 480.

Referring to FIG. 16, the same basic steps are followed here as are described in FIG. 14. In the present preferred embodiment, however, when a primary gate 240 is closed, a length of perforated paper-bag material 470 is drawn along a slide table 260 until a proximal end of the paper-bag material 470 is brought into position over a blower exhaust outlet 254. The proximal end of the paper-bag material 470 is then bunched around the blower exhaust outlet 254 and secured there so that no aggregate 210 can escape the paper-bag material 470 when the aggregate 210 is blown in. The distal end of the perforated paper-bag material 470 is cut at a measured point. This ensures that the paper-bag material 470 is of a predetermined length that ensures a predetermined quantity of aggregate 210 will fill the length of paper-bag material 470 to a desired level. The distal end of the perforated paper-bag material 470 that was just cut is closed up. When the primary gate 240 opens, a blower 250 draws the predetermined quantity of aggregate 210 out of a volume chamber 230 and into the length of perforated paper-bag material 470.

Continuing with FIG. 16, the perforated paper-bag material 470 is generally rectangular in shape. The perforated paper-bag material 470 is also designed to expand to accommodate the aggregate 210 so as to form a rectangular perforated bag of EPS media. The length of perforated paper-bag material 470 is lain out within a jig 480 so that the perimeter of the rectangular paper-bag material 470 is generally adjacent to the inside perimeter of the jig 480. The jig 480 is generally rectangular in shape and is positioned horizontally atop the slide table 260. The rectangular jig 480 surrounds the perimeter of the paper-bag material 470 so as to ensure that the length of perforated paper-bag material 470 maintains a generally rectangular shape when filled with aggregate 210. Given that the jig 480 bounds the perimeter of the paper-bag material 470, the length and width of the perforated paper-bag material 470 will be determined by the length and width of the jig 480. Similarly, each of the four sides of the jig 480 extends upward from the slide table 260, generally perpendicular to the upper surface of the slide table 260. The four sides of the jig 480 extend to a height that ensures the jig 480 dictates the height of the perforated paper-bag material 470 when the material 470 is filled with aggregate 210. In this way, the jig 480 maintains the length, width, and height dimensions of the perforated paper-bag material 470 as each length of the paper-bag material 470 is filled with aggregate 210.

Still referring to FIG. 16, after the length of perforated paper-bag material 470 has been filled with aggregate 210, the proximal end of the paper-bag material 470 is removed from the blower exhaust outlet 254 and closed up. The filled perforated paper-bag material 470 is now a completed preassembled EPS-filled paper bag 30′″. The paper bag 30′″ is removed from the slide table 260, and a new length of perforated paper-bag material 470 is drawn forward along the table 260 within the jig 480 until a proximal end of the paper-bag material 470 is brought into position over the blower exhaust outlet 254. The next preassembled EPS-filled paper bag 30′″ is now ready to be constructed.

Regarding FIG. 16, note that when new dimensions for preassembled EPS-filled paper bags 30′″ are introduced to the manufacturing process, the dimensions of a jig 480 are adjusted to accommodate the new dimensions of the paper bags 30′″. The adjustability of the jig 480 provides for the manufacture of EPS-filled paper bags 30′″ of various widths, lengths, and heights. In an alternate embodiment, lengths of netting are substituted for lengths of paper-bag material 470, resulting in the manufacture of preassembled EPS-netted bags that are of a rectangular shape. FIGS. 12 and 13 show a drainfield 25′ comprising one or more rectangular, preassembled, EPS-filled paper bags 30′″ like the EPS-filled paper bags 30′″ manufactured by the present preferred embodiment.

The present invention is not necessarily limited to the embodiments herein shown and described. Rather, those skilled in the art will appreciate that numerous modifications, as well as adaptations to particular circumstances, will fall within the scope of the present invention as herein shown and described.

What is claimed is:

1. A distribution grid for use in dispersing effluent in a treatment system, the distribution grid comprising:
an elongated, enclosed distribution member having sides defining an internal chamber, the distribution member having an inlet end for receiving effluent into the internal chamber and a perforated bottom side conforming in shape to a first elongated enclosed filter media unit across which the distribution member is horizontally installed; and
plural effluent distribution arms extending laterally from a first vertical side of the distribution member, one end of the distribution arms communicating with the internal chamber and having perforations therein for passing effluent to filter media underneath the distribution arms.

2. The distribution grid recited in claim 1, wherein the first elongated enclosed filter unit comprises a volume of filter media in a cellulosic enclosure.

3. The distribution grid recited in claim 2, wherein the cellulosic enclosure comprises a paper tube.

4. The distribution grid recited in claim 3, wherein the paper tube has sufficient structural strength to permit rigorous shipping and handling.

5. The distribution grid recited in claim 4, wherein the filter media underneath the distribution arms comprises at least one paper tube filled with filter media.

6. The distribution grid recited in claim 1, further comprising a second plurality of effluent distribution arms extending laterally from a second vertical side of the distribution member to communicate with the internal chamber, the second plurality of distribution arms having perforations therein for passing effluent to filter media underneath the second plurality of distribution arms.

7. A distribution grid for distributing effluent comprising:
a primary distribution member having a front end for receiving fluid and a pair of sidewalls with each sidewall having a plurality of openings spaced longitudinally along the sidewall; and
a plurality of lateral distribution arms with means for distributing fluid and an end attached to the primary distribution member at a corresponding opening.

8. The distribution grid recited in claim 7 wherein the primary distribution member further comprises a bottom surface with means for distributing effluent to a filter media under the distribution member.

9. The distribution grid recited in claim 8 wherein the primary distribution member has a bottom side that is generally flat.

10. The distribution grid recited in claim 8 wherein the primary distribution member has a bottom side that is generally concave for positioning the primary distribution member atop and in conformity with a cylinder of filter media.

11. The distribution grid recited in claim 7 wherein the end of each lateral distribution arm is held securely within the corresponding opening of the sidewalls of the primary distribution member by a friction fit.

12. The distribution grid recited in claim 7, further comprising a transition adaptor for coupling a conventional pipe to the front end of a distribution member having a cross-sectional shape that does not conform to that of the pipe.
